(19) United States
(12) Patent Application Publication
(10) Pub. No.: US 2017/0040114 A1
(43) Pub. Date: Feb. 9, 2017

(54) CAPACITOR AND MANUFACTURING METHOD THEREFOR

(71) Applicant: Murata Manufacturing Co., Ltd., Nagaokakyo-shi (JP)

(72) Inventors: Hiromasa Saeki, Nagaokakyo-shi (JP); Takeo Arakawa, Nagaokakyo-shi (JP)

(21) Appl. No.: 15/228,177

(22) Filed: Aug. 4, 2016

(30) Foreign Application Priority Data
Aug. 6, 2015 (JP) 2015-156261

(51) Int. Cl. H01G 4/30; H01G 4/08; H01G 4/008

(52) U.S. Cl. CPC H01G 4/306; H01G 4/008; H01G 4/085

(57) ABSTRACT

A capacitor that includes a conductive porous base material that has a porous part at a first principal surface thereof, and a second principal surface opposite the first principal surface; a dielectric layer on the porous part; an upper electrode on the dielectric layer; and a conductive material layer on the second principal surface of the conductive porous base material.

### CROSS REFERENCE TO RELATED APPLICATIONS

The present application claims priority to Japanese Patent Application No. 2015-156261, filed Aug. 6, 2015, the entire contents of which are incorporated herein by reference.

### BACKGROUND OF THE INVENTION

1. Field of the Invention

The present invention relates to a capacitor and a manufacturing method therefor.

2. Description of the Related Art

In recent years, with higher-density mounting of electronic devices, capacitors with higher electrostatic capacitance have been required. As such a capacitor, for example, Nanotechnology 26 (2015) 064002 discloses therein a capacitor that has an A1203 layer as a dielectric layer and a TiN layer as an upper electrode formed on a porous body comprising a carbon nanotube with the use of an (ALD) method. Besides the porous body in Nanotechnology 26 (2015) 064002, an example of the porous bodies as mentioned above is metallic porous bodies of etched metallic foil, such as aluminum porous foil (WO 2009/118774 A).

### SUMMARY OF THE INVENTION

When a porous base material is prepared by forming a porous part in foil with the use of alternating-current etching or direct-current etching as in WO 2009/118774 A, pores may pass through the foil. In addition, stress applied to the porous base material during the formation of the porous part, in the preparation of a capacitor, or the like may form pores or cracks passing through the foil. This is significant particularly when the foil for the porous base material is thin. When there are holes (pores) passing through the porous base material as just described, a dielectric layer, an electrode, and the like formed on the porous part of the base material can wrap around the rear surface of the base material, thereby causing capacitor defects such as a short circuit or a defective withstand voltage.

An object of the present invention is to provide a highly reliable capacitor which causes no capacitor defect, such as a short circuit or a defective withstand voltage, even when a porous base material has pores passing therethrough, and a method for manufacturing the capacitor.

As a result of earnestly carrying out studies in order to solve the problem mentioned above, the inventors have found the formation of a conductive material layer on a principal surface on the side opposite to a porous principal surface of a conductive porous base material of a capacitor can seal holes passing through the base material, and suppress capacitor defects.

According to a first aspect of the present invention, a capacitor is provided which includes a conductive porous base material that has a porous part at a first principal surface thereof, and a second principal surface opposite the first principal surface; an upper electrode located on a side of the first principal surface of the conductive porous base material; a dielectric layer between the upper electrode and the conductive porous base material; and a conductive material on the second principal surface of the conductive porous base material.

According to a second aspect of the present invention, a conductive porous member for a capacitor is provided, the conductive porous member having a porous part with a first principal surface and a second principal surface opposite the first principal surface, and a conductive material layer on the second principal surface.

According to a third aspect of the present invention, a method for manufacturing a capacitor is provided. The method includes preparing a conductive porous base material that has a porous part at a first principal surface and a second principal surface opposite the first principal surface; forming a conductive material layer on the second principal surface of the conductive porous base material; forming a dielectric layer on the porous part by first atomic layer deposition method; and forming an upper electrode on the dielectric layer by a second atomic layer deposition method.

According to aspects of the present invention, the provision of the conductive material layer on the rear surface (that is, the second principal surface of the conductive porous base material where no porous part is present) of the conductive porous base material of the capacitor can prevent the electrode formed on the base material from wrapping around the rear surface of the base material, thereby providing a capacitor which a low defect percentage.

### BRIEF DESCRIPTION OF THE DRAWINGS

FIG. 1A is a schematic cross-sectional view of a capacitor 1 according to an embodiment of the present invention, and FIG. 1B is a schematic plan view of a conductive metallic substrate of the capacitor 1; and

FIG. 2A is an enlarged view of a high-porosity part in the capacitor in FIGS. 1A and 1B, and FIG. 2B is a diagram schematically illustrating a layered structure in the high-porosity part.

### DETAILED DESCRIPTION OF PREFERRED EMBODIMENTS OF THE INVENTION

Capacitors according to the present invention will be described in detail below with reference to the drawings. However, the shapes and arrangement of the capacitor according to the present embodiment and respective components thereof are not limited to the illustrated examples.

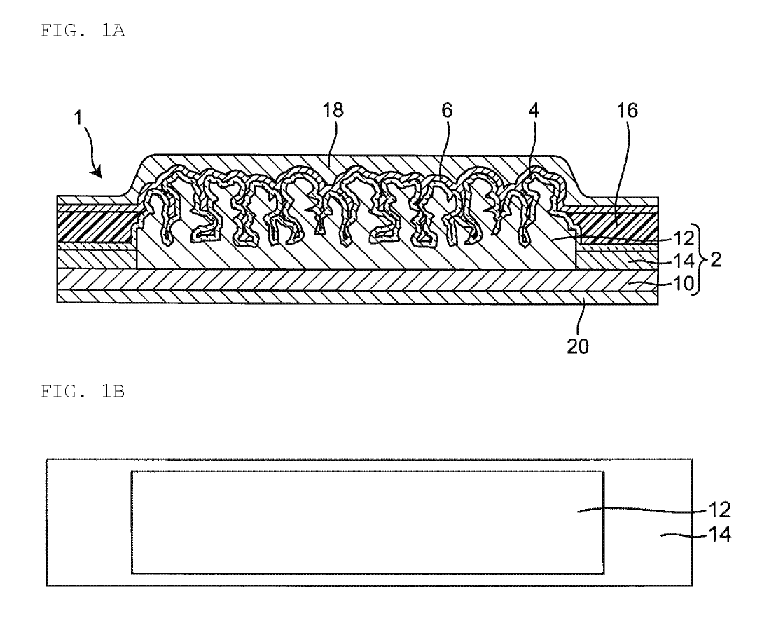

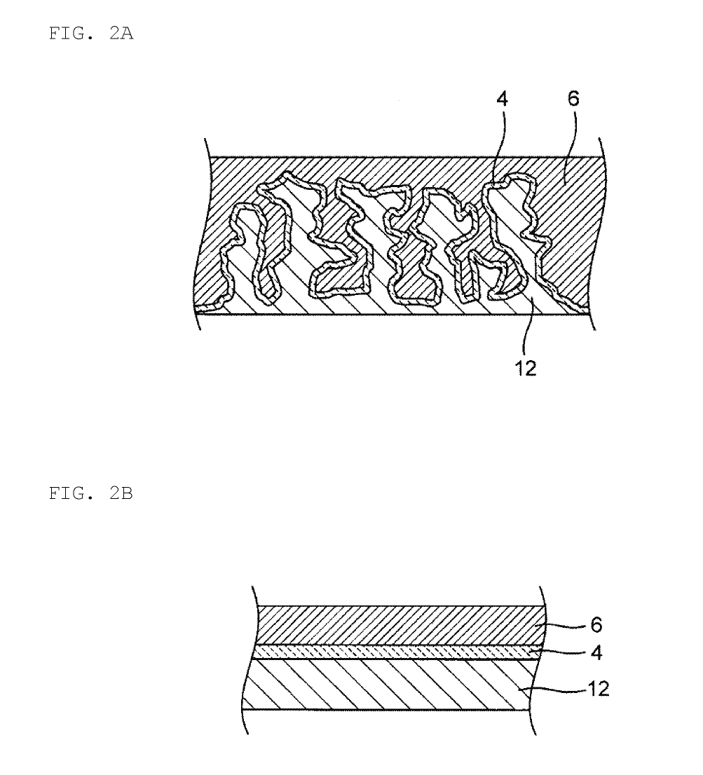

FIG. 1A shows a schematic cross-sectional view of a capacitor 1 according to the present embodiment, and FIG. 1B shows a schematic plan view of a conductive porous base material 2. In addition, FIG. 2A shows an enlarged view of a high-porosity part 12 of the conductive porous base material 2, and FIG. 2B schematically shows a layered structure of the high-porosity part 12, a dielectric layer 4, and an upper electrode 6.

As shown in FIGS. 1A, 1B, 2A, and 2B, the capacitor 1 according to the present embodiment has a substantially cuboid shape, and is schematically configured to include the conductive porous base material 2, the dielectric layer 4 formed on the conductive porous base material 2, and the upper electrode 6 formed on the dielectric layer 4. The conductive porous base material 2 has, at one principal surface side, a high-porosity part 12 that has relatively higher porosity, and a low-porosity part 14 that has relatively lower porosity. The high-porosity part 12 is centrally located at a first principal surface of the conductive porous base material 2, and the low-porosity part 14 is located around the high-porosity part. More specifically, the low-porosity part 14 surrounds the high-porosity part 12. The high-porosity part 12 has a porous structure, that is, corresponding to the porous part according to the present invention. In addition, the conductive porous base material 2 has a supporting part 10 at the other principal surface (second principal surface) side. More specifically, the high-porosity part 12 and the low-porosity part 14 constitute the first principal surface of the conductive porous base material 2, whereas the supporting part 10 constitutes the second principal surface of the conductive porous base material 2. In FIG. 1A, the first principal surface serves as the upper surface of the conductive porous base material 2, whereas the second principal surface serves as the lower surface of the conductive porous base material 2. At an end part of the capacitor 1, there is an insulating part 16 between the dielectric layer 4 and the upper electrode 6. The capacitor 1 includes an external electrode 18 on the upper electrode 6, and a conductive material layer 20 on a principal surface of the conductive porous base material 2 closer to the supporting part 10. In the capacitor 1 according to the present embodiment, the external electrode 18 is electrically connected to the upper electrode 6, and the conductive material layer 20 is in close contact with the second principal surface of the conductive porous base material 2. The upper electrode 6 and the high-porosity part 12 of the conductive porous base material 2 are opposed to each other with the dielectric layer 4 interposed therebetween, and charges can be accumulated in the dielectric layer 4 when current is applied to the upper electrode 6 and the conductive porous base material 2.

The conductive porous base material 2 has a porous structure, and the material and composition thereof are not limited as long as the surface is conductive. Examples of the conductive porous base material include a porous metallic base material, or a base material with a conductive layer formed on the surface of a porous silica material, a porous carbon material, or a porous ceramic sintered body. In a preferred embodiment, the conductive porous base material is a porous metallic base material.

Examples of the metal constituting the porous metallic base material include metals such as aluminum, tantalum, nickel, copper, titanium, niobium, and iron, and alloys such as stainless steel and duralumin. Preferably, the porous metallic base material is an aluminum porous base material.

The conductive porous base material 2 has the high-porosity part 12 and the low-porosity part 14 at one principal surface (first principal surface) side, and the supporting part 10 at the other principal surface (second principal surface) side.

The term “porosity” herein refers to the proportion of voids in the conductive porous base material. The porosity can be measured in the following way. It is to be noted that while voids of the porous part mentioned above can be eventually filled with the dielectric layer, the upper electrode, and the like in the process of preparing the capacitor. In calculation of the “porosity”, filled sites are also counted as voids, without considering the substances filling as just described.

First, a porous metallic base material is processed, by a FIB (Focused Ion Beam) micro-sampling method, into a thin section sample of 60 nm or less in thickness. A predetermined region (3 μm×3 μm) of the thin section sample is subjected to measurement by STEM (Scanning Transmission Electron Microscope)-EDS (Energy Dispersive X-ray Spectrometry) mapping analysis. The area of the porous metallic base material in which the metal is present is figured out in the visual field of the mapping analysis. Then, the porosity can be calculated from the following equality.

Porosity (%)=((Measured Area−Area of Base Material in which Metal is Present)/Measured Area)×100

This measurement is made at any three locations, and the average of the measurement values is regarded as a porosity.

The term “high-porosity part” herein means a part that has higher porosity than the supporting part and low-porosity part of the conductive porous base material.

The high-porosity part 12 has a porous structure. The high-porosity part 12 with the porous structure increases the specific surface area of the conductive porous base material, and further increases the capacitance of the capacitor.

The porosity of the high-porosity part can be preferably 20% or more, more preferably 30% or more, and further preferably 35% or more, from the perspective of increasing the specific surface area and of further increasing the capacitance of the capacitor. In addition, from the perspective of ensuring the mechanical strength, the porosity is preferably 90% or less, and more preferably 80% or less.

The high-porosity part is not particularly limited, but preferably has an expanded surface ratio of 30 times or more and 10,000 times or less, more preferably 50 times or more and 5,000 times or less, for example, 300 times or more and 600 times or less. In this regard, the expanded surface ratio refers to the ratio of the surface area per unit projected area. The surface area per unit projected area can be obtained from the amount of nitrogen adsorption at a liquid nitrogen temperature with the use of a BET specific surface area measurement system.

The term “low-porosity part” herein means a part that has lower porosity as compared with the high-porosity part. Preferably, the porosity of the low-porosity part is lower than the porosity of the high-porosity part, and higher than the porosity of the supporting part.

The porosity of the low-porosity part is preferably 20% or less, more preferably 10% or less. In addition, the low-porosity part may have a porosity of 0%. More specifically, the low-porosity part may have a porous structure, but there is no need to have any porous structure. The mechanical strength of the capacitor is improved as the porosity of the low-porosity part is lower.

It is to be noted that the low-porosity part is not an essential component, and does not have to be present. For example, the supporting part 10 may surround the high-porosity part 12 without the low-porosity par 14 in FIG. 1A.

The conductive porous material, in the present embodiment, comprises the high-porosity part and the low-porosity part present around the high-porosity part at one principal surface; however, the present invention is not limited thereto. More specifically, the high-porosity part and the low-porosity part are not particularly limited in terms of their locations, the numbers located, sizes, and shapes, and the ratio of the high-porosity part to the low-porosity part, and the like. For example, one principal surface of the conductive porous base material may include only the high-porosity part. In addition, the capacitance of the capacitor can be controlled by adjusting the ratio of the high-porosity part to the low-porosity part.

The thickness of the high-porosity part 12 described above is not particularly limited, and can be appropriately selected for a purpose; and the thickness may be, for example, 10 μm or more, and preferably 30 μm or more, and preferably 1000 μm or less, more preferably 300 μm or less, and further preferably 50 μm or less.

The porosity of the supporting part of the conductive porous base material is preferably lower for fulfilling the function as the supporting part, specifically, preferably 10% or less, and more preferably, there is substantially no void in the supporting part.

The thickness of the supporting part 10 is not particularly limited, but is preferably 10 μm or more, and can be, for example, 30 μm or more, 50 μm or more, or 100 μm or more in order to increase the mechanical strength of the capacitor. In addition, from the perspective of achieving a lower-profile capacitor, the thickness is preferably 1000 μm or less, and can be, for example, 500 μm or less or 100 μm or less.

The thickness of the conductive porous base material 2 is not particularly limited, and can be appropriately selected for a purpose; and the thickness may be, for example, 20 μm or more, and preferably 30 μm or more, and for example, 1000 μm or less, preferably 100 μm or less, more preferably 70 μm or less, and further preferably 50 μm or less.

The method for manufacturing the conductive porous base material 2 is not particularly limited. For example, the conductive porous base material 2 can be manufactured in a method in which an appropriate metallic material is processed by a method of forming a porous structure, a method of filling a porous structure, or a method of removing a porous structure part, or a combined method thereof.

The metallic material for manufacturing the conductive porous base material can be a porous metallic material (for example, etched foil) or a metallic material without any porous part (for example, metallic foil), or a combined material thereof. The method for the combination is not particularly limited, and examples thereof include a method of attaching by welding or with a conductive adhesive material or the like.

The method for forming the porous part is not particularly limited, and preferred examples thereof include etching, for example, direct-current or alternating-current etching. As mentioned below, the conductive porous base material according to the present invention has the conductive material layer at the second principal surface, and thus can prevent capacitor defects, such as short circuits, even when the base material has through holes produced by etching. Accordingly, the conductive porous base material for use in the present invention can be manufactured by etching with the use of a thinner material.

The method for filling the porous structure of the porous part is not particularly limited, and examples thereof include a method of melting the metal by laser irradiation or the like, thereby filling pores, or a method of compressing by mold processing or press working, thereby filling pores. The laser mentioned above is not particularly limited, and examples thereof include a CO₂ laser, a YAG laser, and an excimer laser, as well as all-solid-state pulsed lasers such as a femtosecond laser, a picosecond laser, and a nanosecond laser. The all-solid-state pulsed lasers such as a femtosecond laser, a picosecond laser, and a nanosecond laser are preferred because the shape and the porosity can be controlled with more precision.

The method for removing a part of the porous part is not particularly limited, and examples thereof include dicer processing and abrasion processing.

In a method, the conductive porous base material 2 can be manufactured by preparing a porous metallic material, and filling holes at sites corresponding to the supporting part 10 and low-porosity part 14 of the porous metallic base material.

The supporting part 10 and the low-porosity part 14 do not need to be formed at the same time, and may be formed separately. For example, first, the site corresponding to the supporting part 10 of the porous metallic base material may be processed to form the supporting part 10, and then, the site corresponding to the low-porosity part 14 may be processed to form the low-porosity part 14.

In another method, the conductive porous base material 2 can be manufactured by processing a site of a metallic base material without any porous structure (for example, metallic foil), which correspond to the high-porosity part, thereby forming a porous structure.

In yet another method, the conductive porous base material 2 without the low-porosity part 14 can be manufactured by filling holes at a site of a porous metallic material, which corresponds to the supporting part 10, and then removing a site corresponding to the low-porosity part 14.

According to the present embodiment, a conductive material layer 20 is formed on the second principal surface of the conductive porous base material 2 closer to the supporting part 10.

The conductive material layer 20 is provided to seal pores, holes, or cracks passing through the supporting part 10 in the conductive porous base material 2, if any. Disposing the conductive material layer 20 can seal pores, holes, or cracks passing through the supporting part 10 in the conductive porous base material 2, thus preventing the dielectric layer or the upper electrode from being formed to wrap around from the through holes or the like to the second principal surface during the formation of the dielectric layer or upper electrode on the first principal surface of the conductive porous base material 2. As a result, capacitor defects are inhibited.

The conductive material layer 20 has only to be provided at sites where through holes are present in the conductive porous base material 2, but is preferably provided so as to cover the entire second principal surface.

The thickness of the conductive material layer 20 is not particularly limited, and can be preferably 1 μm or more, more preferably 5 μm or more, for example, 50 μm or more or 100 μm or more. The adjustment of the thickness of the conductive material layer to 1 μm or more can further reliably seal the through holes present in the conductive porous base material. On the other hand, the thickness of the conductive material layer can be preferably 500 μm or less, more preferably 300 μm or less, for example, 100 μm or less or 50 μm or less. The reduced thickness of the conductive material layer can achieve a lower-profile capacitor.

The material constituting the conductive material layer 20 is not particularly limited, and can be preferably a material that is different from the material of the supporting part 10 of the conductive porous base material; and examples thereof include metals such as Au, Pb, Pd, Ag, Sn, Ni, and Cu, and alloys. The method for forming the conductive material layer is not particularly limited, and is, for example, a CVD method, electrolytic plating, electroless plating, vapor deposition, sputtering, baking of a conductive paste, welding, adhesion, and the like can be used; and electrolytic plating and electroless plating are preferred because of ease of sealing through holes or cracks which can be present in the conductive porous base material.

In the capacitor 1 according to the present embodiment, the dielectric layer 4 is formed on the high-porosity part 12 and the low-porosity part 14.

The material that forms the dielectric layer 4 is not particularly limited as long as the material has an insulating property, but preferably examples thereof include metal oxides such as AlOₓ (for example, Al₂O₃), SiOₓ (for example, SiO₂), AlTiOₓ, SiTiOₓ, HfOₓ, TaOₓ, ZrOₓ, HfSiOₓ, ZrSiOₓ, TiZrOₓ, TiZrWOₓ, TiOₓ, SrTiOₓ, PbTiOₓ, BaTiOₓ, BaSrTiOₓ, BaCaTiOₓ, and SiAlOₓ; metal nitrides such as AlNₓ, SiNₓ, and AlScNₓ; and metal oxynitrides such as AlOₓN_{y}, SiOₓN_{y}, HfSiOₓN_{y}, and SiCₓO_{y}N_{z}, and AlOₓ, SiOₓ, SiOₓN_{y}, and HfSiOₓ are preferred. It is to be noted that the formulas mentioned above are merely intended to represent the constitutions of the materials, but not intended to limit the compositions. More specifically, the x, y, and z attached to O and N may have any value larger than 0, and the respective elements including the metal elements may have any presence proportion.

The thickness of the dielectric layer is not particularly limited, and is, for example, preferably 5 nm or more and 100 nm or less, and more preferably 10 nm or more and 50 nm or less. The adjustment of the thickness of the dielectric layer to 5 nm or more can enhance the insulating property, thereby making it possible to reduce the leakage current. In addition, the adjustment of the thickness of the dielectric layer to 100 nm or less makes it possible to achieve higher electrostatic capacitance.

The dielectric layer described above is preferably formed by a gas phase method, for example, a vacuum deposition method, a chemical vapor deposition (CVD) method, a sputtering method, an atomic layer deposition (ALD) method, a pulsed laser deposition (PLD) method, or the like. The ALD method is more preferred because a more homogeneous and denser film can be formed even in fine pores of the porous member.

In the capacitor 1 according to the present embodiment, the insulating part 16 is provided on an end part of the dielectric layer 4. Disposing the insulating part 16 can prevent short circuits between the upper electrode 6 disposed on the insulating part and the conductive porous base material 2.

It is to be noted that, although the insulating part 16 is present over the entire low-porosity part 14 in the present embodiment, the presence is not limited thereto; and the insulating part 16 may be present only over a part of the low-porosity part 14, or present over the low-porosity part, even over the high-porosity part.

In addition, although the insulating part 16 is located between the dielectric layer 4 and the upper electrode 6 in the present embodiment, the location is not limited thereto. The insulating part 16 only has to be located between the conductive porous base material 2 and the upper electrode 6, and may be located, for example, between the low-porosity part 14 and the dielectric layer 4.

The material forming the insulating part 16 is not particularly limited as long as the material has an insulating property, but a resin that has heat resistance is preferred in the case of subsequently using an atomic layer deposition method. Various types of glass materials, ceramic materials, polyimide resins, and fluorine-containing resins as the insulating material forming the insulating part 16.

The thickness of the insulating part 16 is not particularly limited, and is preferably 1 μm or more, and can be, for example, 5 μm or more or 10 μm or more, in order to further ensure that end surface discharge is prevented. In addition, from the perspective of achieving a lower-profile capacitor, the thickness is preferably 100 μm or less, and can be, for example, 50 μm or less or 20 μm or less.

It is to be noted that the insulating part 16 is not an essential element in the capacitor according to the present invention, and does not have to be present.

In the capacitor 1 according to the present embodiment, the upper electrode 6 is formed on the dielectric layer 4 and the insulating part 16.

The material constituting the upper electrode 6 is not particularly limited as long as the material is conductive, but examples thereof include: Ni, Cu, Al, W, Ti, Ag, Au, Pt, Zn, Sn, Pb, Fe, Cr, Mo, Ru, Pd, and Ta and alloys thereof such as CuNi, AuNi, AuSn, and metal nitrides and metal oxynitrides such as TiN, TiAlN, TiON, TiAlON, TaN, and conductive polymers (for example, PEDOT(poly(3,4-ethylenedioxythiophene)), polypyrrole, polyaniline); and TiN and TiON, are preferred.

The thickness of the upper electrode is not particularly limited, and is, for example, 3 nm or more, and more preferably 10 nm or more. The adjustment of the thickness of the upper electrode to 3 nm or more can reduce the resistance of the upper electrode itself.

The upper electrode may be formed by an ALD method. The use of the ALD method can increase the capacitance of the capacitor. The upper electrode may be formed by, as an alternative method, a method such as a chemical vapor deposition (CVD) method, plating, a bias sputtering, a Sol-Gel method, conductive polymer filling, or the like, which can coat the dielectric layer and substantially fill pores of the porous metallic base material. Preferably, the upper electrode may be formed in a way that a conductive film is formed by an ALD method on the dielectric layer, and thereon, pores are filled by another approach with a conductive material, preferably a substance that has lower electrical resistance. This configuration can achieve a higher capacitance density and a lower equivalent series resistance (ESR) in an effective manner.

It is to be noted that when the upper electrode has insufficient conductivity as a capacitor electrode after the formation of the upper electrode, an extension electrode layer comprising Al, Cu, Ni, or the like may be additionally formed on the surface of the upper electrode by a method such as sputtering, vapor deposition, or plating.

According to the present embodiment, the first external electrode 18 is formed on the upper electrode 6.

The material constituting the first external electrode 18 is not particularly limited, and example thereof include metals such as Au, Pb, Pd, Ag, Sn, Ni, and Cu, and alloys, as well as conductive polymers. The method for forming the first external electrodes is not particularly limited; and, for example, a CVD method, electrolytic plating, electroless plating, vapor deposition, sputtering, baking of a conductive paste, and the like can be used, and electrolytic plating, electroless plating, vapor deposition, sputtering, and the like are preferred.

It is to be noted that, although the first external electrode 18 is disposed on the entire upper surface of the capacitor, the disposition is not limited thereto; and the first external electrode 18 can be disposed in any shape and size only on a part of each surface. In addition, the first external electrode 18 is not an essential element, and does not have to be present. In this case, the upper electrode 6 also functions as the first external electrode. More specifically, the upper electrode 6 and the conductive material layer 20 may function as a pair of electrodes. In this case, the upper electrode 6 may function as an anode, whereas the conductive material layer 20 may function as a cathode. Alternatively, the upper electrode 6 may function as a cathode, whereas the conductive material layer 20 may function as an anode.

In the present embodiment, a thickness of the end part (preferably a peripheral part) of the capacitor can be equal to or smaller than that of a central part, but preferably be equal thereto. The end part has a large number of layers laminated, and easily undergoes a change in thickness due to cutting, and the variation in thickness can be increased. Accordingly, the reduced thickness of the end part can reduce the influence on the overall size (in particular, thickness) of the capacitor.

The capacitor has a substantially cuboid shape in the embodiment described above, but the present invention is not limited to the shape. The capacitor according to the present invention can be made into any shape, and for example, the planar shape may be circular, elliptical, quadrangular with rounded corners, or the like.

While the capacitor 1 according to the present embodiment has been described above, various modifications can be made to the capacitor according to the present invention.

For example, a layer for enhancing interlayer adhesion, a buffer layer for preventing the diffusion of constituents between the respective layers, or the like may be provided between the respective layers. In addition, the side surface or the like of the capacitor may be provided with a protective layer.

In addition, while the conductive porous base material 2, the dielectric layer 4, the insulating part 16, and the upper electrode 6 are disposed in this order at the end part of the capacitor in the present embodiment, the present invention is not limited to this order. For example, this disposing order is not particularly limited as long as the insulating part 16 is located between the upper electrode 6 and the conductive porous base material 2; and, for example, the conductive porous base material 2, the insulating part 16, the dielectric layer 4, and the upper electrode 6 may be disposed in this order.

Furthermore, the capacitor 1 according to the present embodiment has the upper electrode and the external electrode extending to reach edges of the capacitor, but the present invention is not limited thereto. In an embodiment, the upper electrode (preferably the upper electrode and the first external electrode) is disposed away from the edges of the capacitor. This disposition can prevent end surface discharge. More specifically, the upper electrode may be formed not to cover the entire porous part or be formed to cover only the high-porosity part.

Furthermore, the capacitor according to the present invention may have a second external electrode over the conductive material layer. The second external electrode can be formed in the same way from the same material as the first external electrode described above.

The method for manufacturing the capacitor according to the present invention is not particularly limited as long as the method seals through holes in the conductive porous base material with the conductive material layer, and then forms the upper electrode thereon.

More specifically, the capacitor according to the present invention can be manufactured by a method including:

(1) preparing a conductive porous base material that has a porous part at a first principal surface;

(2) forming a conductive material layer on a second principal surface of the conductive porous base material, and then forming a dielectric layer on the porous part by an atomic layer deposition method, or

(2′) forming the dielectric layer on the porous part by the atomic layer deposition method, and then forming the conductive material layer on the second principal surface of the conductive porous base material; and

(3) forming an upper electrode on the dielectric layer by an atomic layer deposition method.

In addition, the formation of through holes may be prevented alternatively by forming the conductive material layer on one principal surface of a base material without any porous part formed, and then forming a porous part.

Accordingly, the capacitor according to the present invention can be manufactured by a method including:

(1) preparing a base material having a first principal surface and a second principal surface opposed to the first principal surface;

(2) forming a conductive material layer on the second principal surface of the base material;

(3) forming a porous part on the first principal surface of the base material after forming the conductive material layer;

(4) forming a dielectric layer on the porous part by a first atomic layer deposition method; and

(5) forming an upper electrode on the dielectric layer by a second atomic layer deposition method.

In a preferred embodiment, the conductive material layer is formed on the second principal surface of the conductive porous base material before forming the dielectric layer. Accordingly, the capacitor according to the present invention can be manufactured by a method including:

preparing a conductive porous base material that has a porous part at a first principal surface thereof;

forming a conductive material layer on a second principal surface of the conductive porous base material, the second principal surface being opposite the first principal surface;

forming a dielectric layer on the porous part by a first atomic layer deposition method; and

forming an upper electrode on the obtained dielectric layer by a second atomic layer deposition method.

In the embodiment mentioned above, the conductive material layer is first formed on the second principal surface of the conductive porous base material. More specifically, a member is obtained which has the porous part at the first principal surface and has the conductive material layer on the second principal surface. Accordingly, the present invention also provides a conductive porous member for a capacitor, which has a porous part at a first principal surface and has a conductive material layer on a second principal surface.

### EXAMPLES

### Example 1

### Preparation of Metallic Base Material

Two types of aluminum foil with different thicknesses were prepared, and subjected to etching at one side, and thereby two types of aluminum etching foil were obtained. The aluminum etching foil thicknesses were respectively 70 μm and 50 μm.

(Preparation of Sample)

The aluminum etching foil was subjected to patterning with the use of a laser so as to leave a capacitance formation part. Next, only the surfaces subjected to no etching (hereinafter, each of which is also referred to as a “rear surface”) were subjected to a zincate treatment, and then Ni electroless plating to form Ni layers of 5 μm in thickness.

Then, a dielectric layer of Al₂O₃ of 15 nm in thickness was formed with the use of an ALD method. Specifically, a step of alternately supplying a trimethyl aluminum (Al(CH₃)₃) gas and water vapor (H₂O) to the aluminum etching foil was repeated a predetermined number of times, thereby forming an Al₂O₃ film on the foil. Next, a SiO₂ film of 15 nm in thickness was formed on the A1203 layer with the use of an ALD method. Specifically, a step of alternately supplying tris dimethylamino silane (SiH[N(CH₃)₂]₃) and water vapor (H₂O) was repeated a predetermined number of times, thereby forming a SiO₂ film on the Al₂O₃ film.

Then, an upper electrode layer of TiN of 10 nm in thickness was formed with the use of an ALD method. Specifically, a step of alternately supplying a TiCl₄ (titanium tetrachloride) gas and an ammonia (NH₃) gas was repeated a predetermined number of times, thereby forming a TiN layer on the SiO₂ film.

Next, the foil principal surfaces were both subjected to Cu plating to form external electrodes of 5 μm in thickness, thereby preparing capacitors A and B according to the present invention.

### Comparative Example 1

Capacitors C and D according to this comparative example were prepared in the same way as in Example 1, except that no Ni layer was formed on the rear surface of the aluminum etching foil.

(Test Example)

For each of the capacitors A to D prepared above, 100 capacitors were subjected to a withstand voltage measurement, and the number of short-circuited capacitors was counted. The results are shown in the following table.

TABLE 1

| | | Ni Plating for | The Number of Short-Circuited |
|---|---|---|---|
| Capacitor | Thickness | Rear Surface | Capacitors |
| A | 70 μm | Yes | 0 |
| B | 50 μm | Yes | 2 |
| C | 70 μm | No | 6 |
| D | 50 μm | No | 100 |

### Example 2

Capacitors A′ and B′ according to the present invention were prepared in the same way as in Example 1, except that, as the plated layer on the rear surface of the aluminum etching foil, a Cu layer of 8 μm was adopted with the use of Cu electrolytic plating.

### Comparative Example 2

Capacitors C′ and D′ according to this comparative example were prepared in the same way as in Example 2, except that no Cu layer was formed on the rear surface of the aluminum etching foil.

(Test Example)

For each of the capacitors A′ to D′ prepared above, 100 capacitors were subjected to a withstand voltage measurement, and the number of short-circuited capacitors was counted. The results are shown in the following table.

TABLE 2

| | | Ni Plating for | The Number of Short-Circuited |
|---|---|---|---|
| Capacitor | Thickness | Rear Surface | Capacitors |
| A′ | 70 μm | Yes | 0 |
| B′ | 50 μm | Yes | 1 |
| C′ | 70 μm | No | 7 |
| D′ | 50 μm | No | 95 |

From the results described above, it has been confirmed that the number of short-circuited capacitors can be reduced significantly by providing the conductive material layer on the rear surface of the aluminum etching foil. This is believed to be because the conductive material layer formed on the rear surface seals through holes formed in the aluminum etching foil. In addition, this effect is greater when the conductive porous base material with a smaller thickness is used.

The capacitor according to the present invention is, because of its remarkable stability and high reliability, used for various electronic devices in a preferred manner. The capacitor according to the present invention is mounted onto a board and used as an electronic component. Alternatively, the capacitor according to the present invention is embedded in a board or an interposer and used as an electronic component.

What is claimed is:

1. A capacitor comprising:
a conductive porous base material that has a porous part at a first principal surface thereof, and a second principal surface opposite the first principal surface;
an upper electrode opposing the first principal surface of the conductive porous base material;
a dielectric layer between the upper electrode and the conductive porous base material; and
a conductive material layer on the second principal surface of the conductive porous base material.

2. The capacitor according to claim 1, wherein the conductive porous base material is 70 μm or less in thickness.

3. The capacitor according to claim 2, wherein the conductive material layer is 1 μm or more in thickness.

4. The capacitor according to claim 1, wherein the conductive material layer is 1 μm or more in thickness.

5. The capacitor according to claim 1, wherein the dielectric layer is an atomic deposition layer.

6. The capacitor according to claim 1, wherein the upper electrode is an atomic deposition layer.

7. The capacitor according to claim 1, wherein a first material of the conductive material layer is different from a second material of the second principal surface of the conductive porous base material.

8. The capacitor according to claim 1, wherein the conductive material layer comprises copper as a main constituent thereof.

9. The capacitor according to claim 1, wherein the conductive material layer comprises nickel as a main constituent thereof.

10. A conductive porous member comprising:
a porous part having a first principal surface and a second principal surface opposing the first principal surface; and
a conductive material layer on the second principal surface.

11. The conductive porous member according to claim 10, wherein the conductive material layer is 1 μm or more in thickness.

12. The conductive porous member according to claim 10, wherein a first material of the conductive material layer is different from a second material of the second principal surface of the porous part.

13. The conductive porous member according to claim 10, wherein the conductive material layer comprises copper as a main constituent thereof.

14. The conductive porous member according to claim 10, wherein the conductive material layer comprises nickel as a main constituent thereof.

15. A method for manufacturing a capacitor, the method comprising:
(1) preparing a conductive porous base material that has a porous part at a first principal surface thereof, and a second principal surface opposite the first principal surface;
(2) forming a conductive material layer on the second principal surface of the conductive porous base material;
(3) forming a dielectric layer on the porous part; and
(4) forming an upper electrode on the dielectric layer.

16. The method for manufacturing a capacitor according to claim 15, wherein the dielectric layer is formed by an atomic layer deposition method.

17. The method for manufacturing a capacitor according to claim 15, wherein the upper electrode is formed by an atomic layer deposition method.

18. The method for manufacturing a capacitor according to claim 15, wherein the dielectric layer is formed by a first atomic layer deposition method; and the upper electrode is formed by a second atomic layer deposition method.

19. The method for manufacturing a capacitor according to claim 15, wherein the conductive material layer if formed before the dielectric layer.

20. The method for manufacturing a capacitor according to claim 15, wherein the dielectric layer is formed before the conductive material layer.
